(19) United States
(12) Patent Application Publication
(10) Pub. No.: US 2004/0020722 A1
(43) Pub. Date: Feb. 5, 2004

(54) Automatic transmission

(76) Inventors: Thomas Neufischer, Friedrichshafen (DE); Andreas Steinert, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/276,538

(22) PCT Filed: May 19, 2001
(86) PCT No.: PCT/EP01/05759

(30) Foreign Application Priority Data
May 24, 2000 (DE) 100 25 682.1

(51) Int. Cl. F16H 57/04

(52) U.S. Cl. 184/6

(57) ABSTRACT

The automatic transmission for motor vehicles has a housing, in which a multiplicity of clutches and brakes are placed, as well as an input shaft and an output shaft and at least one torque transmitting shaft (1). This torque transmitting shaft (1) has an axial, central boring (3) and a plurality of radial, transverse borings. The transverse borings are cylindrical borings (6), having a transition radius (7) at the outlet. The outlet is connected to the cylindrical boring part by a conical transition part.

The present invention concerns an automatic transmission for motor vehicles, having a housing in which a multiplicity of clutches and borings are placed, and having further an input shaft and an output shaft, as well as a torque transmitting shaft. The torque transmitting shaft possesses a central boring and several borings transverse thereto, which serve as the supply of pressurized hydraulic fluid to individual components, in accord with the principal concept of Claim 1.

Torque transmitting shafts with borings transverse to the central axis are applied in stepless automatic transmissions as well as in stepped transmissions for the distribution of pressurized hydraulic fluid to individual components. Normally the said transverse borings are cylindrical borings with a transitional radius opening.

An example of a stepped automatic transmission is described by the Applicant in DE 199 08 840. The stepped automatic transmission exhibits, in this case, a plurality of clutches and brakes. At least some of the clutches are designed as wet, multi-disk clutches having an inner and an outer disk carrier, where in the stepping automatic transmission, the inner disk carrier turns and the outer disk carrier stands still during the state of operation. The disconnect clutch stands still and the outer disk carrier turns, is provided with a centrifugal pot, which is coaxially placed within the inner disk carrier with the hollow shaft and is in connection with a continually rotating component of the clutch. For this purpose, the outer wall of the centrifugal pot is provided with borings.

The hollow torque transmitting shaft delivers cooling oil to the clutch. The coding oil flows through the radial, transverse borings in the torque transmitting shaft.

An example of a stepless automatic transmission having a disk clutch is described by the Applicant in P 197 34 839. This automatic transmission, having a steel thrust belt on a disk-set connected to a primary shaft, exhibits in the disk clutch, a disk packet, having inner and outer disks. The inner disks are borne in an inner disk carrier and the outer disks are carried by an outer disk carrier and the disk packet can be pressed together with a piston.

The outer disk carrier is designated like a basket and is located at a given distance on the side of the piston which is distal from the disk-set. With this arrangement, the outside disk carrier on its side proximal to the piston, is constructed to be open, and is force fit to a drive shaft by means of toothed engagement. Further the primary shaft, serving as a hollow, torque transmitting shaft, has transverse borings for the introduction of lubrication oil for cooling of the disk packet. These transverse borings, are usually constructed as cylindrical borings with a transition radius at the opening.

Experience has shown, that under certain circumstances such torque transmitting shafts in motor vehicle automatic transmissions become subject to breakage, because of notch effect stresses.

As a result of notch effect stresses, the fissures of breakage begin in the opening area of the transverse borings.

An increase of the material strength of these torque transmitting shafts, the transverse borings, by means of using a better shaft material, or by optimizing the hardening process, could not be considered based on the high costs of such improvement.

The effort had already been made, to vary the position, the number and the diameter of the transverse borings, as well as to diminish the notch effect by an improvement of the surfacing quality. With these alterations, the oil quantity for the optimal operation of the automatic transmission was frequently limited to an unacceptable degree.

The purpose of the present invention is to increase the material strength of automatic transmission torque transmitting shafts having transverse borings without simultaneously incurring additional costs.

On the basis of an automatic transmission, of the generic type described in more detail in the introductory passages, the achievement of this purpose is described by the given features in the characterized part of the principal claim. An advantageous embodiment is set forth in the subordinate claims.

Considerations will now be based on an automatic transmission for motor vehicles, having at least one torque transmitting shaft, which has an axial, central boring and a plurality of radial transverse borings. These borings are designed to supply pressure to individual components by means of a hydraulic fluid. The transverse borings are made as cylindrical borings with a transition radius at the opening. The proposal, made in accord with the invention, is that the opening zone is to have a conical shape. Advantageously, the conical opening area fares into to the cylindrical boring without any surface irregularity.

In a surprising manner, the discovery was made, that the material strength of the torque transmitting shaft is increased, when the opening area is formed as a conical shape. The reason for increase in material strength is that the stresses in the opening area are apportioned over a greater area, such that specific stress reduction results. Additionally, because of the funnel like opening of the otherwise cylindrical boring, the flow characteristics of the hydraulic fluid are improved in a measurable amount.

This procedure is further optimized by the use of a special tool, which forms the complete opening zone of the cylindrical transverse boring without having any imperfections in the surface. An opening in the shape of a funnel, i.e., a conical shape, which is uninterrupted by any tooling or shoulder marks, greatly minimizes the notch effect, such that hardening fissures can be reliably avoided.

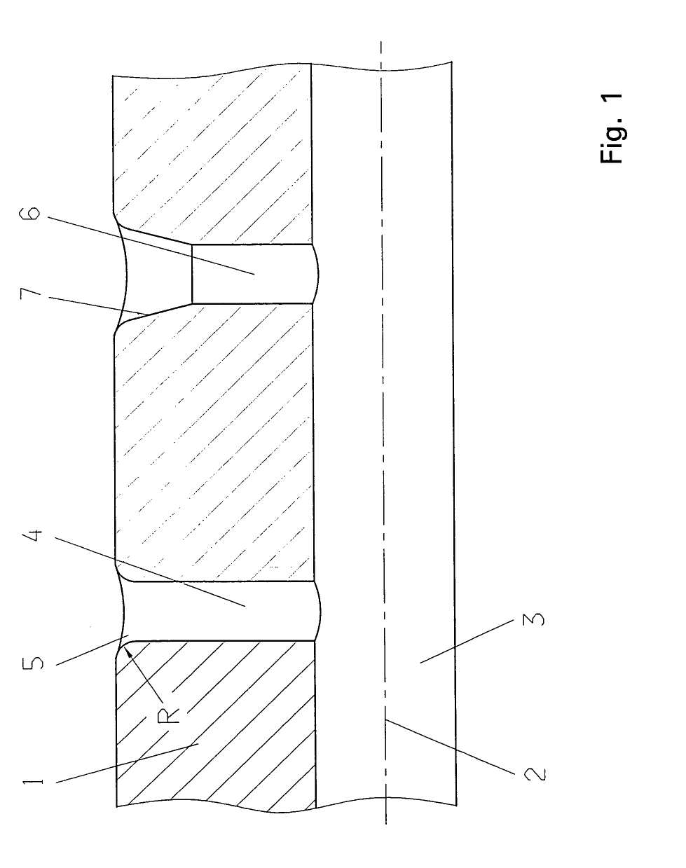

In the following, the invention will be more closely described and explained, with the aid of the drawing, i.e., FIG. 1 of 1, which drawing shows a partial cross-section through a torque transmitting shaft with two cylindrical, transverse borings.

Reference number 1 indicates the torque transmitting shaft and the longitudinal axis is designated by 2. The shaft has an axial, central boring 3, through which a hydraulic fluid flows to the transverse borings 4, 6 thus providing such components with required pressure.

The cylindrical, transverse boring designated 4 seen at the left in the drawing, is shown in the conventional form with an opening area 5. Around the circumference of this type of opening 5, due to notch-effect, under certain operational circumstances, fissures can form, which begin generally in the opening area. This area is shown as having a radius of curvature of R in relation to the cylindrical boring 4.

According to the invention, the cylindrical transverse boring is provided with a conical shape 7 in the opening area. The result would be that the occurring stresses would apportion themselves over a greater area, which would lead to a reduction in stress per area unit. The material strength of the torque transmitting shaft 1 is thereby increased. At the same time, the flow conditions of the hydraulic fluid through this proposed conical, i.e., funnel shaped opening 7 are measurably improved.

It is particularly advantageous to shape the complete opening area for the cylindrical, transverse boring 6 without imperfections in the surface by the use of a special tool. The notch effect is minimized to the extent, that fissures due to hardening can safely be avoided by means of a smooth funnel or boring surface 7.

Claimed is:

1. An automatic transmission for a motor vehicle, with a housing, in which a multiplicity of clutches and brakes are placed, with an input shaft and an output shaft, as well as with at least one torque transmitting shaft (1), which possesses an axial, central boring (3) for the supply of pressure to individual components by means of a hydraulic fluid, as well as a plurality of radial, transverse borings (6), which are made as cylindrical borings with a transition radius at the opening, characterized in that, the opening area exhibits a conical shape (7).

2. An automatic transmission in accord with claim 1, therein characterized, in that the conical opening area (7) fares into the cylindrical transverse boring (6) without surface imperfections.
